(19) United States
(12) Patent Application Publication
(10) Pub. No.: US 2014/0356724 A1
(43) Pub. Date: Dec. 4, 2014

(54) NON-AQUEOUS ELECTROLYTE SECONDARY BATTERY

(71) Applicant: SANYO Electric Co., Ltd., Moriguchi-shi, Osaka (JP)

(72) Inventor: Yasunobu Iwami, Kadoma-shi (JP)

(73) Assignee: SANYO ELECTRIC CO., LTD., Moriguchi-shi, Osaka (JP)

(21) Appl. No.: 14/363,909

(22) PCT Filed: Dec. 20, 2012
(86) PCT No.: PCT/JP2012/083006

§ 371 Date: Jun. 9, 2014

(30) Foreign Application Priority Data
Dec. 22, 2011 (JP) 2011-281041

(51) Int. Cl. H01M 4/36; H01M 10/0525; H01M 4/131; H01M 4/48; H01M 4/485

(52) U.S. Cl. CPC H01M 4/364; H01M 4/483; H01M 4/485; H01M 4/131; H01M 10/0525; H01M 2004/027
USPC 429/231.4

(57) ABSTRACT

A non-aqueous electrolyte secondary battery comprising a positive electrode plate, a negative electrode being provided with a negative electrode plate mixture layer containing a negative electrode active material, a separator; and a non-aqueous electrolyte. The negative electrode active material is a mixture of at least one of metal silicon and silicon oxide expressed by SiOx (0.5≦x<1.6) , and graphite material. And the graphite material includes coated graphite material coated with amorphous carbon in the ratio of equal to or more than 20% by mass, and equal to or less than 90% by mass to all the graphite material, and the ratio of the metal silicon and the silicon oxide to all the negative electrode active material is equal to or more than 1% by mass and equal to or more than 20% by mass.

### TECHNICAL FIELD

The present invention is related to a non-aqueous electrolyte secondary battery which has excellent cycle characteristics, while being suppressed in increase of the battery thickness in the initial stage in cases where silicon metal (Si) or silicon oxide (SiOx) is mixed with a graphite material and used as a negative electrode active material.

### BACKGROUND ART

In recent years, mobile or portable electronic equipment such as mobile telephones (including smartphones), portable computers, PDAs, and portable music players, have been widely used. According to requirements of high functionality, downsizing, and weight-saving in those electronic equipment, as secondary batteries of the drive power sources for those, high capacity is required. Further regulations on emissions of gases causing global warming such as carbon dioxide have been strengthened against a background of growing environmental protection movements in recent years. To address this, the car industry has been actively developing electric vehicles (EVs) and hybrid electric vehicles (HEVs) in place of automobiles using fossil fuels such as gasoline, diesel oil, and natural gas.

Nickel-hydrogen secondary batteries or lithium ion secondary batteries have been generally used as drive power sources for such EVs and HEVs. In recent years, non-aqueous electrolyte secondary batteries such as a lithium ion secondary battery have been widely used because such a battery is lightweight and has high capacity. Furthermore, in stationary storage battery systems for suppressing output fluctuation of solar power generation and wind power generation, and for a peak shift of grid power that utilizes the power during the daytime while saving the power during the nighttime.

Generally, such a non-aqueous electrolyte secondary battery is manufactured in the following. Namely a positive electrode plate and a negative electrode plate interposing a separator therebetween are spirally wound on the cylindrical winding core with them insulated from each other by the separator. And a cylindrical spiral electrode assembly is formed. In the negative electrode plate, a negative electrode mixture layer containing a negative electrode active material is coated on both surfaces of a strip sheet of a conductive metal foil made of a copper foil or the like as a current collector. In the positive electrode plate, a positive electrode mixture layer containing a positive electrode active material is coated on both surfaces of a strip sheet of a conductive metal foil made of an aluminum foil or the like as a current collector. The separator is made of a microporous polyethylene film or the like. In the case of a prismatic battery, the above spiral electrode assembly is pressed into a flat spiral electrode assembly by a press machine so as to insert it into a prismatic battery external container. Next, the cylindrical or prismatic spiral electrode assembly is stored into the corresponding battery external container. And a non-aqueous electrolyte is injected, and then the non-aqueous electrolyte secondary battery is completed.

As the negative electrode active material used in the non-aqueous electrolyte secondary battery, carbonaceous materials such as graphite, amorphous carbon or the like are widely used because of their excellent properties of high safety by inhibiting the growth of dendrites, superior initial efficiency, satisfactory potential flatness and high density while having a discharge potential comparable to that of a lithium metal or lithium alloy. However, in the negative electrode active material consisting of the carbonaceous materials, lithium is inserted only up to the composition of LiC₆, so its theoretical capacity is at most 372 mAh/g. It is difficult to increase a battery capacity.

Therefore, non-aqueous electrolyte secondary battery has been developed by using silicon forming an alloy with lithium, a silicon alloy or silicon oxide as a negative electrode active material with high capacity per unit mass and per unit volume. In this case, for example, as lithium is inserted up to the composition of Li4.4Si, its theoretical capacity is 4200 mAh/g. Thus, its expected capacity is much higher than the carbonaceous materials as the negative electrode active material. However when the materials such as silicon forming an alloy with lithium, a silicon alloy, or a silicon oxide as a negative electrode active material are used, since large expansion and contraction as the charge and discharge cycle proceeds, they are susceptible to pulverization or falling off conductive network. As a result, a non-aqueous electrolyte battery has a problem that charge-discharge cycle characteristics may be deteriorated. To solve the problem, various improvements have been developed.

For example, the below patent literature describes the following non-electrolyte battery. Its negative electrode comprises a negative electrode active material mixture layer containing a graphite and a material which includes silicon and oxygen (the element ratio x of silicon to oxygen is 0.5≦x≦1.5) as a constituent element. When the total of the graphite and the material including the silicon and the oxygen as the constituent element is taken as 100% by mass, the ratio of the material including the silicon and the oxygen is 3 to 20% by mass. The non-aqueous electrolyte secondary battery uses the silicon oxide having the high capacity and the large volume variation in charging and discharging, and it suppresses the deterioration of the battery characteristics from the large volume variation. It has the excellent battery characteristics without greatly changing the configuration of the conventional non-aqueous electrolyte secondary battery.

### CITATION LIST

### Patent Literature

Patent Literature 1:

### Japanese Laid-Open Patent Publication No. 2010-212228

### SUMMARY OF THE INVENTION

It is necessary to leave the non-aqueous electrolyte secondary battery for a determined period after injecting a non-aqueous electrolyte into the battery, in order to sufficiently spread the non-aqueous electrolyte to its electrode plates and separators, and then charge and discharge the battery. When the non-aqueous electrolyte secondary battery in a state of not charging at all is left, the negative electrode potential is equal to or more than 3 V based on lithium and it is an electropositive potential compared with the dissolution potential of cupper which is usually used as a negative electrode core. So the core made of cupper is dissolved, in the worst case there is a possibility of an internal short. Therefore, in order to leave the battery for the predetermined period, by a little charging, the negative electrode potential needs to have an electropositive potential compared with the potential at which the core made of cupper is dissolved (hereinafter referred to as “charging before leaving”).

Conditions of the charging before leaving are different in the specifications of the non-aqueous electrolyte secondary battery, and as a result of the past considerations the battery is charged to a state of charge of approximately 5 to 10% based on a full charge state of the negative electrode. Charging to less than 5% is insufficient as the charging capacity for leaving. It is necessary to stabilize a reduction film formed on the surface of the negative electrode at the initial charge state. When a charging capacity is less than 5%, forming of the reduction film is insufficient. Consequently, the reduction film is decomposed during the leaving, and then the potential of the negative electrode becomes an electropositive potential compared with the potential of the reduction film forming.

In this case, the reduction film on the negative electrode is formed during the charging after the leaving. As a result of the irreversible film forming, lithium ions are consumed again and the battery capacity decreases. In addition, a gas generation with the above additional forming of the reduction film causes an increase in the thickness of a prismatic battery. On the other hand, when the battery is charged to a state of charge of more than 10%, namely a depth of charge is increased in an inadequate state of electrolyte infiltration, which causes ununiform reaction on the electrode. Accordingly, there can be a high probability of manufacturing the battery which does not have a designed battery capacity.

Further, when the negative electrode active material containing the mixture in which the silicon or the silicon oxide is mixed with the graphite is used, based on the characteristics of a charging profile of the negative electrode active material, as charging of the silicon or the silicon oxide proceeds at the early time of charging, the depth of charge of the graphite in the negative electrode active material containing the mixture is relatively lower than the depth of charge of the whole negative electrode active material containing the mixture. Therefore, in using the negative electrode active material containing the mixture, when the charging before leaving is carried out in the same way as the conventional graphite, the following problems occur. Since it is impossible to stabilize the reduction film formed on the surface of the negative electrode, the full battery capacity becomes smaller than the designed capacity. In addition, the increase in the battery thickness of the prismatic battery occurs at the early stage.

The present disclosure is developed for solving the aforementioned problems, and aims to provide a non-aqueous electrolyte secondary battery that exhibits excellent cycle characteristics and little increase in the thickness of the battery in the case of using the mixture of the graphite material, and silicon or the silicon oxide as the negative electrode active material.

A non-aqueous electrolyte secondary battery of the present disclosure comprises a positive electrode plate being provided with a positive electrode mixture layer containing a positive electrode active material capable of absorbing and desorbing lithium ions, a negative electrode being provided with a negative electrode mixture layer containing a negative electrode active material capable of absorbing and desorbing lithium ions, a separator, and a non-aqueous electrolyte. The negative electrode active material is a mixture of at least one of metal silicon and silicon oxide expressed by SiOx (0.5≦x<1.6) and a graphite material, and the graphite material includes coated graphite material coated with amorphous carbon in the ratio of equal to or more than 20% by mass and equal to or less than 90% by mass to all the graphite materials and the ratio of metal silicon and silicon oxide to the whole negative electrode active material is equal to or more than 1% by mass and equal to or less than 20% by mass.

The non-aqueous electrolyte secondary battery of the present disclosure contains not only the graphite material but also at least one of metal silicon and silicon oxide expressed by SiOx as the negative electrode active material. Although metal silicon and silicon oxide expressed by SiOx has the larger volume variation in charging and discharging than that of a graphite material, those have higher theoretical capacity than that of graphite material. So the non-aqueous electrolyte secondary battery of the present disclosure has higher battery capacity than that of a non-aqueous electrolyte secondary battery having a negative electrode active material containing only graphite material.

In addition, the negative electrode active material used in the non-aqueous electrolyte secondary battery of the present disclosure contains the coated graphite material coated with amorphous carbon. The coated graphite material coated with amorphous carbon scarcely decomposes the non-aqueous electrolyte, and has effect of gas adsorption on its superficial pores or the like. A reduction film in the negative electrode is hardly decomposed during the initial leaving after charging when the coated graphite material is equal to or more than 20% by mass to all the graphite materials. Then, an expansion of the battery is suppressed. Here, when the coated graphite material is 100% by mass, the expansion of the battery is suppressed. However, charge-discharge cycle characteristics are deteriorated. Therefore, the ratio of the coated graphite material coated with amorphous carbon to all the graphite materials is preferably equal to or less than 90% by mass.

It is considered that such an effect occurs by the following reason. Namely, in the coated graphite material coated with amorphous carbon, contacts between particles in the negative electrode active material are done through amorphous carbon. Resistances between particles in the negative electrode active material are high, compared with the graphite material without amorphous carbon. Therefore, when only the coated graphite material coated with amorphous carbon is used, as charge and discharge cycle proceeds, resistances between particles of the negative electrode active material become high. However, by using a mixture of the coated graphite material and the graphite material without amorphous carbon, it is suppressed that resistances between particles of the negative electrode active material become high during charging and discharging cycle, and the deterioration of charge-discharge cycle characteristics is suppressed.

Further, regarding the ratio of metal silicon and silicon oxide to the whole negative electrode active material, when the ratio is less than 1% by mass, there is no effect of the addition of metal silicon and silicon oxide. In addition, when the ratio is more than 20% by mass, a reduction film in the negative electrode is largely decomposed. Consequently, the expansion of the battery is large, and charge-discharge cycle characteristics are deteriorated.

In the non-aqueous electrolyte secondary battery of the present disclosure, the ratio of the coated graphite material coated with the amorphous carbon to all the graphite materials is preferably equal to or more than 50% by mass and equal to or less than 90% by mass. When the ratio of the coated graphite material coated with the amorphous carbon to all the graphite material is equal to or more than 50% by mass, the expansion of the battery during the initial leaving after charging is suppressed.

In the non-aqueous electrolyte secondary battery of the present disclosure, the ratio of the coated amorphous carbon to the coated graphite material coated with the amorphous carbon is preferably equal to or more than 0.1% by mass and equal to or more than 6.5% by mass. When the ratio of the coated amorphous carbon to the coated graphite material coated with the amorphous carbon is less than 0.1% by mass, charge-discharge cycle characteristics are good. However, the expansion of the battery during the initial leaving after charging is not suppressed. When that ratio is more than 6.5% by mass, the expansion of the battery during the initial leaving after charging is suppressed. However, charge-discharge cycle characteristics are deteriorated. More preferably the ratio of the coated amorphous carbon to the coated graphite material coated with the amorphous carbon is equal to or more than 0.5% by mass and equal to or less than 5% by mass.

In the non-aqueous electrolyte secondary battery of the present disclosure, the positive electrode plate using the compound that can reversibly adsorb and desorb lithium ions as the positive electrode active material is properly selected. As the positive electrode active material of the non-aqueous electrolyte secondary battery, lithium transition-metal composite oxides expressed by LiMO₂ (where M is at least one of Co, Ni, and Mn) that can reversibly adsorb and desorb lithium ions, namely LiCoO₂, LiNiO₂, LiNiyCo1—yO₂ (y=0.01 to 0.99), LiMnO₂, LiCoₓMn_{y}Ni_{z}O₂ (x+y+z=1), LiMn₂O₄, LiFePO₄, and the like are used singly or as a mixture of two or more of them. Further, dissimilar metallic element added lithium-cobalt composite oxides are also used, and zirconium, magnesium, aluminum or the like is used as dissimilar metal element.

Examples of a non-aqueous solvent that can be used in the non-aqueous electrolyte secondary battery of the present disclosure include: cyclic carbonates such as ethylene carbonate (EC), propylene carbonate (PC), and butylene carbonate (BC); fluorinated cyclic carbonates; cyclic carboxylic esters such as γ-butyrolactone (γ-BL) and γ-valerolactone (γ-VL); chain carbonates such as dimethyl carbonate (DMC), ethyl methyl carbonate (EMC), diethyl carbonate (DEC), methylpropyl carbonate (MPC), and dibutyl carbonate (DBC); fluorinated chain carbonates; chain carboxylic esters such as methyl pivalate, ethyl pivalate, methyl isobutyrate, and methyl propionate; amide compounds such as N,N′-dimethylformamide and N-methyl oxazolidinone; and sulfur compounds such as sulfolane; and ambient-temperature molten salts such as tetrafluomboric acid and 1-ethyl-3-methylimidazolium. It is desirable that two or more of them are used in combination.

Here, when the non-aqueous electrolyte contains fluoroethylene carbonate, its content is preferably equal to or more than 0.1% by volume, and equal to or less than 35% by volume to the non-aqueous solvent. When the non-aqueous electrolyte contains fluoroethylene carbonate, fluoroethylene carbonate increases the viscosity of the non-aqueous electrolyte and reduces the diffusibility of lithium ions. Therefore, the expansion of the battery during the leaving after the initial charging is adequately suppressed, and charge-discharge cycle characteristics exhibit good. However, when the additive amount of fluoroethylene carbonate is small, the effects of the addition of fluoroethylene carbonate are not adequately shown. When the additive amount of fluoroethylene carbonate is large, the expansion of the battery during the leaving after the initial charging is adequately suppressed, charge-discharge cycle characteristics are good, but discharge load characteristics degrease. More preferably, the content of fluoroethylene carbonate is equal to or more than 0.5% by volume, and equal to or less than 30% by volume to the non-aqueous electrolyte.

To the nonaqueous electrolyte used in the present disclosure, the following compounds may be further added for stabilizing the electrodes: vinylene carbonate (VC), vinyl ethyl carbonate (VEC), propane sultone (PS), succinic anhydride (SUCAH), maleic anhydride (MAAH), glycolic anhydride, ethylene sulfite (ES), divinyl sulfone (VS), vinyl acetate (VA), vinyl pivalate (VP), catechol carbonate, and biphenyl. Two or more of these compounds can also be used in combination as appropriate.

Lithium salts commonly used as the electrolyte salt in a non-aqueous electrolyte secondary battery can be used as electrolyte salts in the non-aqueous solvent used in the non-aqueous electrolyte secondary battery of the present disclosure. Examples of such a lithium salt include LiPF₆, LiBF₄, LiCF₃SO₃, LiN (CF₃SO₂)₂, LiN (CF₂F₅SO₂)₂, LiN (CF₃SO₂) (C₄F₉SO₂), LiC(CF₃SO₂)₃, LiC (C₂F₅SO₂)₃, LiAsF₆, LiClO₄, Li₂B₁₀Cl₁₀, Li₂B₁₂Cl₁₂, or the like and mixtures of them. Among them, especially LiPF₆ (Lithium hexafluorophosphate) is desirable. The amount of electrolyte salt dissolved in the non-aqueous solvent is preferably 0.8 to 1.5 mol/L.

### DESCRIPTION OF EMBODIMENTS

Embodiments for carrying out the invention will now be described in detail based on examples and comparative examples. It is to be understood, however, that the following embodiments are intended as an illustrative example of a non-aqueous electrolyte secondary battery for embodying the technical concepts of the invention, and are not intended to limit the invention to the embodiments. The invention can be equally applied to various modifications without departing from the technical concepts set forth in the claims.

### [Preparation of Positive Electrode Plate]

For the positive electrode plate, zirconium-, magnesium-, and aluminum-added lithium cobalt oxide (LiCo_{0.979} Zr_{0.001}Mg_{0.01}Al_{0.01}O₂) was prepared as follows. At the time of synthesizing cobalt carbonate, 0.1 mol % of zirconium, 1 mol % of magnesium, and 1 mol % of aluminum to cobalt were coprecipitated. Subsequently, thermal decomposition was performed, and zirconium, magnesium, and aluminum-added tricobalt tetraoxide was obtained. Thereafter, the tricobalt tetraoxide and lithium carbonate as the lithium source was mixed and calcined at 850° C. for 20 hours.

The above synthesized powder of the zirconium, magnesium, and aluminum-added lithium cobalt oxide (LiCo0.979 Zr0.001Mg0.01Al0.01O2) as a positive electrode active material, a powder of graphite material as a conductive agent, and a powder of polyvinylidene fluoride as a binder were mixed in the ratio of 95:2.5:2.5 by mass. The resultant mixture was dispersed in N-methyl-2-pyrrolidone (NMP) to make a positive electrode mixture slurry. This positive electrode mixture slurry was coated on both surfaces of a 15 μm (=micrometer) thick positive electrode collector made of aluminum by the doctor blade method, and a positive electrode mixture layer containing the positive electrode active material was formed on each of both surfaces of the collector. Then after drying it, it was pressed with a roll press, and by cutting it into the predetermined size the positive electrode plate was made.

### [Preparation of Negative Electrode Plate]

(1) Preparation of Silicon Oxide Active Material

Particles of the composition of SiOx (x=1) as silicon oxide were coated with carbon under an argon atmosphere by the CVD method. A disproportionation treatment of the particles after carbon coating was carried out at 1000° C. (degree celsius) under an argon atmosphere. Then by pulverizing and classifying the particles, SiO coated with carbon was obtained. Here as effects of the embodiment is obtained regardless of carbon coating, the step of carbon coating is not indispensable. In addition, conventional various methods can be used as a method of coating carbon.

(2) Preparation of Negative Electrode Plate

Scale-shaped artificial graphite having an average particle diameter of 20 μm (micro meter) as graphite without amorphous carbon coating, graphite coated with amorphous carbon, and silicon oxide were weighed and mixed to prepare a negative electrode active material. The graphite coated with amorphous carbon was prepared in the following way. Scale-shaped artificial graphite as a core and petroleum pitch as a precursor for coating the core with amorphous carbon were prepared. Those were mixed and calcined under an inert gas atmosphere. After that, by pulverizing and classifying, the graphite having an average particle diameter of 20 μm (=micrometer) whose surface was coated with amorphous carbon was prepared. The coating amount of amorphous carbon was defined as the ratio of amorphous carbon to graphite particles coated with amorphous carbon. This negative electrode active material, carboxymethylcellulose (CMC) as a thickener, and styrene-butadiene rubber (SBR) as a binder, were mixed in the ratio of 97:1.5:1.5 by mass and the mixture was dispersed in NMP to make a negative electrode mixture slurry. This negative electrode mixture slurry was coated on both surfaces of an 8 μm thick negative electrode collector made of copper by the doctor blade method, and the negative electrode mixture layer containing the negative electrode active material was formed on each of both surfaces of the collector. Then after drying it, it was pressed with a roll press, and by cutting it into the predetermined size the positive electrode plate was made.

### [Preparation of Non-aqueous Electrolyte]

Ethylene carbonate (EC), methyl ethyl carbonate (MEC), and diethyl carbonate (DEC) were mixed in the proportion of 30:60:10 by volume to prepare a non-aqueous solvent. LiPF6 as an electrolyte salt was dissolved to be 1.2 mol/L. Vinylene carbonate (VC) was added to the solution so as to provide the ratio of 2% by mass to a non-aqueous electrolyte. When fluoroethylene carbonate (FEC) was added, the proportion of each component was adjusted according to the composition shown in Table 4.

### [Preparation of Battery]

As prepared above, the positive electrode plate and the negative electrode plate interposing a separator made of polyethylene microporous membrane therebetween were wound, and by sticking a tape made of polypropylene at its outermost periphery a cylindrical spiral electrode assembly was obtained. After that, it was pressed into a flat spiral electrode assembly. Furthermore, five layer structure of a resin layer (polyethylene)/an adhesive layer/an aluminum alloy layer/an adhesive layer/a resin layer (polyethylene) constitutes a laminated film. The laminated film was fold to form a bottom portion, and a cup-like electrode assembly storing space. Next, in the glove box under an argon atmosphere, the above flat spiral electrode assembly and the non-aqueous electrolyte were inserted into the cup-like electrode assembly storing space. And by reducing the pressure in the laminate outer case, the separator was impregnated with the non-aqueous electrolyte. Then, an opening of the laminate outer case was sealed, and the non-aqueous electrolyte secondary battery which is 62 mm high, 35 mm wide and 3.6 mm thick was obtained. The designed capacity of the obtained non-aqueous electrolyte secondary battery was 800 mAh at 4.4 V of the charging cut-off voltage.

### [Measurement of Increase of Battery Thickness]

When batteries were charged with constant current of 1 lt=800 mA to 7% compared with the full charge capacity at 4.4 V of charging cut-off voltage as the designed battery capacity at 25° C. (degree Celsius), battery thicknesses were measured. Next, in order to promote the impregnation of the non-aqueous electrolyte, the batteries are left for 1 day in the constant temperature oven keeping at 60° C. (degree Celsius). And then, a thickness of the each battery after 1 day leaving was measured, and variation of the thickness before and after the leaving was calculated as an increase of the battery thickness.

### [Measurement of Cycle Capacity Retention Rate (=Cycle Capacity %) at 25° C. (Degree Celsius)]

At 25° C. (degree Celsius), batteries were charged with a constant current of 1 lt=800 mA, and after the battery voltage reached 4.4 V, the batteries are charged with a constant voltage of 4.4 V until a charging current reached 40 mA. After that, the batteries were discharged with a constant current of 1 lt=800 mA until 2.75 V of the batteries. Such charging and discharging were taken as the first cycle, and the discharge capacity of the first cycle was measured. The charge and discharge cycle on the same condition as that of the first cycle was repeated 300 times, and the discharge capacity at the 300th cycle was measured. And then, the ratio of the discharge capacity at the 300th cycle to the discharge capacity at the first cycle was calculated as a capacity retention rate (=cycle capacity %).

### [Measurement of Load Characteristics (2 It/1 It Discharge Load Characteristics)]

At 25° C. (degree Celsius), batteries were charged with constant current of 1 lt=800 mA, and after the battery voltage reached 4.4 V, the batteries were charged with constant voltage until a charging current reached 40 mA. After that, the batteries are discharged with constant current of 1 lt=800 mA until 2.75 V of the batteries. Such charging and discharging were taken as the first cycle, and the discharge capacity of the first cycle was measured.

Next at 25° C. (degree Celsius), the batteries were charged with constant current of 1 lt=800 mA, and after the battery voltage reached 4.4 V, the batteries were charged with constant voltage until a charging current reached 40 mA. After that, the batteries were discharged with constant current of 2 lt=1600 mA until 2.75 V of the batteries. Such charging and discharging was taken as the second cycle, and the discharge capacity of the second cycle was measured. And then, the ratio of the discharge capacity at the second cycle to the discharge capacity at the first cycle was calculated as a 2 It/1 It discharge load characteristics.

### Examples 1 to 4 and Comparative Examples 1 to 3

In the non-aqueous electrolyte secondary batteries of Examples 1 to 4 and Comparative Examples 1 to 3, the following materials as the negative electrode active materials were used. The coating amount of amorphous carbon was constant 1% by mass. Added amount of silicon oxide expressed by the composition formula SiOx (x=1) in all the negative electrode active materials (namely the content rate of the silicon oxide to all the negative electrode active material) was constant 3.5% by mass. The ratio of graphite without coated amorphous carbon to all graphite was varied 100 to 0% by mass (the ratio of graphite coated with amorphous carbon to all graphite is 0 to 100% by mass). Regarding each of those batteries, as described above, the results of measurements of initial capacity, increase of a battery thickness, and cycle capacity are summarized in table 1 with compositions of the negative electrode active materials.

TABLE 1

| | Graphite Ratio | | | | | |
|---|---|---|---|---|---|---|
| | | Coated* | | | Increase of | |
| | Graphite | Graphite | | | battery | |
| | (% | (% | SiOx | Initial Capa. | thickness. | Cycle Capa. |
| | by mass) | by mass) | (% by mass) | (mAh) | (mm) | (%) |
| Com. Ex. 1 | 100 | 0 | 3.5 | 839 | 0.83 | 79.9 |
| Com. Ex. 2 | 90 | 10 | 3.5 | 840 | 0.74 | 79.3 |
| Example 1 | 80 | 20 | 3.5 | 833 | 0.44 | 81.0 |
| Example 2 | 50 | 50 | 3.5 | 834 | 0.11 | 79.6 |
| Example 3 | 20 | 80 | 3.5 | 835 | 0.09 | 74.4 |
| Example 4 | 10 | 90 | 3.5 | 836 | 0.10 | 72.9 |
| Com. Ex. 3 | 0 | 100 | 3.5 | 829 | 0.08 | 58.8 |

*Coated Graphite coated with 1% by mass amorphous carbon

The results shown in Table 1 reveal the following. Namely, the battery of Comparative Example 1 which did not contain the graphite coated with amorphous carbon, and the battery of Comparative Example 2 which contained 10% by mass of the graphite coated with amorphous carbon were good in initial capacity and cycle capacity, but large in increase of a battery thickness as equal to or more than 0.74 mm. The batteries of Examples 1 to 4 which contained 20 to 90% by mass of the graphite coated with amorphous carbon were not only good in initial capacity and cycle capacity, but also good in increase of a battery thickness as equal to or less than 0.44 mm, so good results were obtained. Here, the battery of Comparative Example 3 which contains 100% by mass of the graphite coated with amorphous carbon was smallest in increase of a battery thickness, good in initial capacity, but very low in cycle capacity as 58.8%. Therefore, the ratio of graphite coated with amorphous carbon to all graphite is preferably equal to or more than 20% by mass and equal to or less than 90% by mass, more preferably equal to or more than 50% by mass and equal to or less than 90% by mass.

### Examples 5 to 7 and Comparative Examples 4 and 5

In the non-aqueous electrolyte secondary batteries of Examples 5 to 7 and Comparative Examples 4 and 5, the following materials as the negative electrode active materials were used. The coating amount of amorphous carbon was constant 1% by mass. The ratio of graphite without coated amorphous carbon to all graphite was constant 80% by mass (the ratio of graphite coated with amorphous carbon to all graphite was constant 20% by mass). Added amount of silicon oxide expressed by the composition formula SiOx (x=1) in all the negative electrode active materials (namely the content rate of the silicon oxide to all the negative electrode active material) was varied 0.5 to 25% by mass. Regarding each of those batteries, as described above, the results of measurements of initial capacity, increase of a battery thickness, and cycle capacity are summarized in table 2 with compositions of the negative electrode active materials.

TABLE 2

| | Graphite Ratio | | | | | |
|---|---|---|---|---|---|---|
| | | Coated* | | | Increase of | |
| | Graphite | Graphite | | | battery | |
| | (% | (% | SiOx | Initial Capa. | thickness. | Cycle Capa. |
| | by mass) | by mass) | (% by mass) | (mAh) | (mm) | (%) |
| Com. Ex. 4 | 80 | 20 | 0.5 | 818 | 0.22 | 81.2 |
| Example 5 | 80 | 20 | 1 | 829 | 0.38 | 81.2 |
| Example 6 | 80 | 20 | 10 | 833 | 0.46 | 66.1 |
| Example 7 | 80 | 20 | 20 | 837 | 0.48 | 62.1 |
| Com. Ex. 5 | 80 | 20 | 25 | 842 | 0.71 | 49.8 |

*Coated Graphite coated with 1% by mass amorphous carbon

The results shown in Table 2 reveal the following. Namely, the battery of Comparative Example 4 in which the added amount of silicon oxide of expressed by the composition formula SiOx (x=1) in all the negative electrode active materials was 0.5% by mass was good in increase of a battery thickness and cycle capacity, but small in initial capacity as 818 mAh. As the result of investigation in which the measured battery was disassembled, the deposition of lithium metal was partially found. The reason is considered in the following. As the added amount of silicon oxide in all the negative electrode active materials was small, the added amount of silicon oxide in the area of the negative electrode plate facing the positive electrode plate was insufficient. Accordingly, it is presumed that the real acceptable amount of lithium ion was smaller than the designed acceptable amount of lithium ion. Therefore, the lithium metal deposited.

On the other, Comparative Example 5 in which the added amount of silicon oxide in all the negative electrode active materials was 25% by mass was very good in initial capacity, but big in increase of a battery thickness as 0.71 mm and very low in cycle capacity as 49.8%. This is the reason why as the added amount of silicon oxide was large, the depth of charge of the graphite in the above charging before leaving was out of the preferable values. Therefore, it is not preferable to add more than 25% by mass of silicon oxide in all the negative electrode active materials. Accordingly, the content ratio of the silicon oxide to all the negative electrode active materials is preferably equal to or more than 0.5% by mass and equal to or less than 20% by mass.

### Examples 8 to 11

In the non-aqueous electrolyte secondary batteries of Examples 8 to 11, the following materials as the negative electrode active materials were used. The ratio of graphite without coated amorphous carbon to all graphite was constant 80% by mass (the ratio of graphite coated with amorphous carbon to all graphite is constant 20% by mass). Added amount of silicon oxide expressed by the composition formula SiOx (x=1) in all the negative electrode active materials (namely the content rate of the silicon oxide to all the negative electrode active material) was constant 3.5% by mass. The coating amount of amorphous carbon was varied 0.1 to 6.5% by mass. Regarding each of those batteries, as described above, the results of measurements of initial capacity, increase of a battery thickness, and cycle capacity are summarized in table 3 with compositions of the negative electrode active materials. Here, the measured results of the battery of Example 1 are also described in table 3.

TABLE 3

| | Graphite Ratio | | Coated | | | Increase of | |
|---|---|---|---|---|---|---|---|
| | Graphite | Coated* | amorphous | | | battery | |
| | (% by | Graphite | carbon | SiOx | Initial Capa. | thickness. | Cycle Capa. |
| | mass) | (% by mass) | (% by mass) | (% by mass) | (mAh) | (mm) | (%) |
| Example 8 | 80 | 20 | 0.1 | 3.5 | 837 | 0.51 | 81.8 |
| Example 9 | 80 | 20 | 0.5 | 3.5 | 838 | 0.47 | 80.5 |
| Example 1 | 80 | 20 | 1.0 | 3.5 | 833 | 0.44 | 81.0 |
| Example 10 | 80 | 20 | 5.0 | 3.5 | 831 | 0.43 | 75.1 |
| Example 11 | 80 | 20 | 6.5 | 3.5 | 838 | 0.45 | 71.0 |

*Amorphous carbon coated graphite

The results shown in Table 3 reveal the following. Namely, the battery of Example 8 in which the coating amount of amorphous carbon was 0.1% by mass was decreased in increase of a battery thickness compared with Comparative Example 1 which did not contain the graphite coated with the amorphous carbon (see table 1), but rather increased in increase of a battery thickness compared with Examples 1, 9 to 11. Further, the battery of Example 11 in which the coating amount of amorphous carbon is 6.5% by mass was decreased in increase of a battery thickness, but rather decreased in cycle capacity. This is considered in the following. In the battery of Example 11, as the coated amorphous carbon film is thick, conductivity between particles of the negative electrode active material is decreased. Since expansion and contraction by repeating the charge and discharge cycle occur, conductive path is broken.

Here, the batteries of Examples 1, 8 to 11 have good results in initial capacity. Accordingly, amorphous carbon coated amount to the coated graphite material coated with the amorphous carbon (namely the content rate of the coated amorphous carbon to the coated graphite material coated with the amorphous carbon) is preferably 0.1 to 6.5% by mass, more preferably 0.5 to 5% by mass.

### Examples 12 to 16

In the non-aqueous electrolyte secondary batteries of Examples 8 to 11, the following materials as the negative electrode active materials were used. The ratio of graphite without coated amorphous carbon to all graphite was constant 50% by mass (the ratio of graphite coated with amorphous carbon to all graphite is constant 50% by mass). Added amount of silicon oxide of expressed by the composition formula SiOx (x=1) in all the negative electrode active materials (namely the content rate of the silicon oxide to all the negative electrode active material) is constant 3.5% by mass. The coating amount of amorphous carbon was constant 1% by mass. And the ratio of fluoroethylene carbonate (FEC) to the non-aqueous electrolyte was varied 0 to 35% by volume.

Here, the proportion in non-aqueous electrolyte of ethylene carbonate (EC), methyl ethyl carbonate (MEC), and diethyl carbonate (DEC) is 30:60:10% by volume. When fluoroethylene carbonate (FEC) was added, the proportion of EC was decreased by the added the proportion of FEC. When fluoroethylene carbonate (FEC) was added more than 30% by volume, the proportion of MEC is further decreased by the proportion of adding FEC exceeding 30% by volume. Moreover, vinylene carbonate (VC) was added to the non-aqueous electrolyte so as to be the ratio of 2% by mass to a nonaqueous electrolyte. This VC is conventionally added to stabilize a reduction film formed on the surface of the negative electrode.

Regarding each of those batteries, as described above, the results of measurements of initial capacity, increase of a battery thickness, cycle capacity, and 2 It/1 It discharge load characteristics are summarized in table 4 with compositions of the negative electrode active materials. Here, the measured results of the battery of Example 2 are also described in table 4.

TABLE 4

| | Graphite Ratio | | | | | Increase of | | 2 It/1 It |
|---|---|---|---|---|---|---|---|---|
| | Graphite | Coated* | SiOx | FEC/EC/ | Initial | battery | | discharge load |
| | (% by | Graphite | (% | MEC/DEC** | Capa. | thickness. | Cycle Capa. | characteristics |
| | mass) | (% by mass) | by mass) | (% by volume) | (mAh) | (mm) | (%) | (%) |
| Example 2 | 50 | 50 | 3.5 | 0/30/60/10 | 834 | 0.11 | 79.6 | 95.4 |
| Example 12 | 50 | 50 | 3.5 | 0.1/29.9/60/10 | 836 | 0.17 | 79.1 | 96.4 |
| Example 13 | 50 | 50 | 3.5 | 0.5/29.5/60/10 | 834 | 0.13 | 82.7 | 95.6 |
| Example 14 | 50 | 50 | 3.5 | 15/15/60/10 | 830 | 0.15 | 84.2 | 92.0 |
| Example 15 | 50 | 50 | 3.5 | 30/0/60/10 | 840 | 0.09 | 84.3 | 91.5 |
| Example 16 | 50 | 50 | 3.5 | 35/0/55/10 | 840 | 0.09 | 84.3 | 87.5 |

*Coated Graphite coated with 1% by mass amorphous carbon
**VC added amount = 2% by mass
FEC: fluoroethylene carbonate
EC: ethylene carbonate
MEC: methyl ethyl carbonate
DEC: diethyl carbonate
VC: vinylene carbonate

The results shown in Table 4 reveal the following. Namely, the batteries of Examples 12 to 16 in which the ratios of fluoroethylene carbonate (FEC) to the non-aqueous electrolyte was 0.1 to 35% by volume had good initial capacities approximately similar to Example 2 containing no FEC. However, increase of a battery thickness in the batteries of Examples 12 to 14 in which the ratios of fluoroethylene carbonate (FEC) to the non-aqueous electrolyte is 0.1 to 15% by volume were a little inferior to Example 2 containing no FEC, but the batteries of Examples 15 and 16 in which the ratios of fluoroethylene carbonate (FEC) to the non-aqueous electrolyte was equal to or more than 30% by volume have better results in increase of a battery thickness than Example 2. In addition, in cycle capacity the batteries of Examples 13 and 15 in which the ratios of fluoroethylene carbonate (FEC) to the non-aqueous electrolyte was equal to or more than 0.5% by volume have better results than Example 2 and 16 in which the ratios of fluoroethylene carbonate (FEC) were equal to or less than 0.1% by volume.

Further, as the ratios of fluoroethylene carbonate (FEC) to the non-aqueous electrolyte increase, 2 It/1 It discharge load characteristics gradually decrease. The battery of Example 16 in which the ratios of fluoroethylene carbonate (FEC) is the maximum of 35% by volume has a good result of 87.5% in 2 It/1 It discharge load characteristics. Such 2 It/1 It discharge load characteristics is considered in the following. As the ratio of fluoroethylene carbonate (FEC) to the non-aqueous electrolyte increases, viscosity of the non-aqueous electrolyte increases, and diffusibility of lithium ion decreases. Therefore, the ratios of fluoroethylene carbonate (FEC) to the non-aqueous electrolyte are preferably 0.1 to 35% by volume, more preferably 0.5 to 30% by volume.

1. A non-aqueous electrolyte secondary battery comprising:
a positive electrode plate being provided with a positive electrode mixture layer containing a positive electrode active material capable of absorbing and desorbing lithium ions;
a negative electrode being provided with a negative electrode mixture layer containing a negative electrode active material capable of absorbing and desorbing lithium ions;
a separator; and
a non-aqueous electrolyte;
wherein the negative electrode active material is a mixture of at least one of metal silicon and silicon oxide expressed by SiOx (0.5≦x<1.6) , and a graphite material,
and the graphite material includes a coated graphite material coated with amorphous carbon in the ratio of equal to or more than 20% by mass and equal to or less than 90% by mass to all the graphite materials,
and the ratio of metal silicon and silicon oxide to the whole negative electrode active material is equal to or more than 1% by mass and equal to or less than 20% by mass.

2. The non-aqueous electrolyte secondary battery according to claim 1, wherein the ratio of the coated graphite material coated with the amorphous carbon to all the graphite material is equal to or more than 50% by mass and equal to or less than 90% by mass.

3. The non-aqueous electrolyte secondary battery according to claim 1, wherein the ratio of the coated amorphous carbon to the coated graphite material coated with the amorphous carbon is equal to or more than 0.5% by mass and equal to or more than 5% by mass.

4. The non-aqueous electrolyte secondary battery according to claim 1, wherein the non-aqueous electrolyte includes fluoroethylene carbonate in the ratio of equal to or more than 0.5% by volume and equal to or less than 30% by volume to the non-aqueous electrolyte.

5. The non-aqueous electrolyte secondary battery according to claim 2, wherein the non-aqueous electrolyte includes fluoroethylene carbonate in the ratio of equal to or more than 0.5% by volume and equal to or less than 30% by volume to the non-aqueous electrolyte.

6. The non-aqueous electrolyte secondary battery according to claims 3, wherein the non-aqueous electrolyte includes fluoroethylene carbonate in the ratio of equal to or more than 0.5% by volume and equal to or less than 30% by volume to the non-aqueous electrolyte.
